(19) United States
(12) Patent Application Publication
(10) Pub. No.: US 2025/0021832 A1
(43) Pub. Date: Jan. 16, 2025

(54) INTERACTIVE DATA LABELING FOR SUBSTRATE GENERATION PROCESSES

(71) Applicant: Applied Materials, Inc., Santa Clara, CA (US)

(72) Inventors: Bharath Ram Sundar, Chennai (IN); Jagadeesh Govindaraj, Tamilnadu (IN); Raman Krishnan Nurani, Chennai (IN); Ramachandran Subramanian, Tamil Nadu (IN); Nusrat Jahan Chhanda, Milpitas, CA (US); Sundar Narayanan, Cupertino, CA (US)

(21) Appl. No.: 18/221,301

(22) Filed: Jul. 12, 2023

(51) Int. Cl. G06N 5/022

(52) U.S. Cl. CPC G06N 5/022

(57) ABSTRACT

A method includes obtaining, by a processing device, first data indicative of substrate generation parameters of a first substrate. The processing device further obtains second data indicative of properties of the first substrate. The processing device further obtains third data indicative of substrate generation parameters of a second substrate. The processing device further receives fourth data indicative of properties of the second substrate. The method further includes providing a user interface (UI). The UI includes a first UI element for presenting a visual depiction of the second data and a second UI element for presenting a visual depiction of the fourth data. The method further includes receiving user input of a classification of the first substrate and the second substrate. The method further includes performing analysis relating the first data and the third data to the user classifications. The method further includes performing a corrective action based on the analysis.

### TECHNICAL FIELD

The present disclosure relates to data analysis for substrate generation procedures, and more specifically the present disclosure relates to interactive data labeling for substrate generation processes.

### BACKGROUND

Products may be produced by performing one or more manufacturing processes using manufacturing equipment. For example, semiconductor manufacturing equipment may be used to produce substrates via semiconductor manufacturing processes. Products are to be produced with particular properties, suited for a target application. Understanding and controlling properties within the manufacturing chamber aids in consistent production of products. Connections between substrate generation parameters and substrate properties may be exploited for design or improvement of substrate generation procedures.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect of the present disclosure, a method includes obtaining, by a processing device, first data indicative of substrate generation parameters of a first substrate. The processing device further obtains second data indicative of properties of the first substrate. The processing device further obtains third data indicative of substrate generation parameters of a second substrate. The processing device further receives fourth data indicative of properties of the second substrate. The method further includes providing a user interface (UI). The UI includes a first UI element for presenting a visual depiction of the second data and a second UI element for presenting a visual depiction of the fourth data. The method further includes receiving user input of a classification of the first substrate and the second substrate. The method further includes performing analysis relating the first data and the third data to the user classifications. The method further includes performing a corrective action based on the analysis.

In another aspect of the present disclosure, a non-transitory machine-readable storage medium stores instructions which, when executed, cause a processing device to perform operations. The operations include obtaining first and second data indicative of processing conditions and properties of a first substrate. The operations further include obtaining third and fourth data indicative of properties of a second substrate. The operations further include providing a UI. The UI includes a first UI element for presenting a visual depiction of the second data and a second UI element for presenting a visual depiction of the fourth data. The operations further include receiving a first user input including a user classification of the first substrate in relation to the second data. The operations further include receiving a second user input including a user classification of the second substrate in relation to the fourth data. The operations further include performing analysis relating the first data and the third data to the first user classification and the second user classification. The operations further include performing a corrective action based on the analysis.

In another aspect of the present disclosure, a system includes memory and a processing device coupled to the memory. The processing device is configured to obtain first and second data indicative of processing conditions and properties of a first substrate. The processing device is further configured to obtain third and fourth data indicative of processing conditions and properties of a second substrate. The processing device is further configured to provide a UI. The UI includes a first and second UI element for presenting a visual depiction of the second and fourth data. The processing device is further configured to receive a first and second user input including first and second user classifications of the first and second substrates in relation to the second and fourth data. The processing device is further configured to perform analysis relating the first data and the third data to the first and second user classifications. The processing device is further configured to perform a corrective action based on the analysis.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to some embodiments.

FIG. 2 depicts an exemplary data flow for utilizing numeric and non-numeric data for substrate processing operation analysis, according to some embodiments.

FIG. 3 depicts an example user interface (UI) element for receiving user labeling, according to some embodiments.

FIG. 4 depicts an example UI element for receiving user labeling of data, according to some embodiments.

FIG. 5 is a flow diagram of a method for performing corrective actions based on interactive data labeling, according to some embodiments.

FIG. 6 is a block diagram illustrating a computer system, according to some embodiments.

### DETAILED DESCRIPTION

Described herein are technologies related to classification methods for virtual and physical substrates, which may further be used for making determinations of substrate generation procedures. Manufacturing equipment may be used to produce products, such as substrates (e.g., wafers, semiconductors, displays, photovoltaics, etc.). Manufacturing equipment (e.g., manufacturing tools) often includes a processing chamber that separates the substrate being processed from the environment. The properties of produced substrates are to meet target property values to facilitate performance, functionality, etc. Anomalies, drift, or other differences in processing environment may generate substrates with sub-optimal performance, e.g., semiconductors that fail to function as intended, inefficiencies in manufacturing (for example, additional expenditure of time, materials, energy, etc.). A processing environment may be quantified by various sensors associated with a processing chamber, e.g., pressure gauges, temperatures sensors, sensors indicative of electrical power (e.g., voltmeters, etc.), gas flow meters, etc. Manufacturing equipment may be used to generate physical substrates.

Simulation models may be utilized to generate virtual substrates, simulated substrates, etc. Substrate processing simulation models may be utilized in generating simulated substrates. Substrate processing simulation models may generate simulated substrates based on relationships between substrate processing conditions used as input to the simulation model and substrate properties generated as output by the simulation model. Simulation models may mimic one or more physical process operations. Simulation models may be utilized for improving physical process operations, designing substrate processing recipes, etc.

Substrate generation procedures include substrate processing simulation models for generating virtual substrates and substrate manufacturing procedures for generating physical substrates. Improving substrate generation procedures may include determining one or more properties of generated substrates. Improving substrate generation procedures may include performing corrective actions based on properties of generated substrates. Improving substrate generation procedures may include classifying substrates based on one or more properties. Improving substrate generation procedures may include relating substrate classifications to substrate generation input parameters, such as model parameters, manufacturing conditions, etc.

In some systems, classification of substrates may be based on data that is not simply represented numerically. For example, presence or absence of one or more features of a substrate, a shape of one or more structures of a substrate, etc. may be easily understood visually (e.g., by a subject matter expert) but may be difficult to classify in an automated manner, as a simple numerical representation may have difficulty capturing the features to be classified.

In some systems, classification of substrates may be cumbersome. For example, classification by subject matter experts may be inconvenient or difficult. Further, providing information relating processing inputs to substrate classifications may be inconvenient; involve multiple steps; involve multiple processing devices, computers, applications, etc.; or the like. Performing analysis based on the classifications may include additional steps, and performance of corrective actions in view of the analysis may include further additional steps. Such sequences of operations may be cumbersome in terms of time commitment, in particular time commitment of subject matter experts.

Methods and systems of the present disclosure may address one or more shortcomings of conventional solutions. In some embodiments, a number of substrates may be generated. The substrates may be virtual substrates, physical substrates, or both. The substrates may be generated subject to substrate generating parameters. The substrate generating parameters may be manufacturing conditions. The substrate generating parameters may be one or more parameters of a substrate processing model. Parameters of a model may be related to manufacturing conditions of a physical substrate manufacturing procedure.

Data indicative of one or more properties of the substrates may be generated. The data may include numeric data. Numeric data may include measurements of one or more dimensions of substrates. Numeric data may include values of one or more properties of the substrates. Numeric data may include combinations of measurements, such as a ratio between different measurements (e.g., an aspect ratio of a feature).

Data indicative of substrate properties may include non-numeric data. Non-numeric data includes any data that may present insights on a substrate generation procedure that is not easily extracted from numbers representing substrate properties. For example, the presence of a feature may be easily discerned visually, but less clear to represent numerically. Non-numeric data may include data that is more easily interpreted (e.g., by a subject matter expert, by a user, etc.) when it is represented non-numerically. Non-numeric data may include data that is processed or understood visually, such as images, animations, etc.

Both numeric and non-numeric data may be generated in association to properties of virtual substrates. Numeric data may include descriptions of material properties of generated substrates. Numeric data may include measurements or dimensions of features of generated substrates. Numeric data may include dimensions of structures of generated substrates. Non-numeric data may include visual indications of substrate properties. Non-numeric data may include images or animations demonstrating substrate properties. Non-numeric data may include images depicted substrate geometry, structure shape and/or size, etc. non-numeric data may include visual representations of substrate properties, such as film stress, flux distributions, etc.

Both numeric and non-numeric data may be generated in association with properties of physical substrates. Non-numeric data may include images taken by metrology systems of the physical substrates. Non-numeric data may include, for example, SEM, optical microscope, or TEM images. Numeric data may include values of properties of the physical substrate. Numeric data may include values of dimensions of the physical substrate. Numeric data may include measurements of structures of the physical substrates.

Substrates may be classified based on their properties. In some cases, classification may be clear from numeric data, e.g., a count of defects may fall above a threshold limit, etc. In some cases, classification may be less clear from numeric data, e.g., whether or not a structure is present may be obvious visually but determining numerically whether the structure is present may be difficult, unreliable, have a low accuracy, etc.

In some embodiments, a user interface (UI) may be presented including indications of data associated with substrates. The UI may include UI elements associated with the substrates. The UI may include UI elements depicting relationships between properties associated with the substrates. For example, the UI may present a marker on a plot depicting first and second substrate generation parameters on the first and second axes. The marker may be associated with a substrate generated with values of the first and second generation parameters indicated. The plot, markers, UI elements, etc., may present numeric data, e.g., based on the location of markers on the plot.

In some embodiments, the UI may present a UI element displaying non-numeric data associated with one or more substrates. The UI may present one or more UI elements displaying non-numeric data associated with one or more substrates. The UI element may display visual indications of non-numeric data associated with substrates. The UI element may display depictions of substrate geometry, substrate properties, etc. The UI may present a UI element including non-numeric data associated with a substrate proximate a marker associated with the substrate. The UI may present a UI element including non-numeric data associated with a substrate upon selection of a marker associated with the substrate. The UI may present a UI element including non-numeric data associated with a substrate upon cursor hover or dwell at a marker associated with the substrate.

The UI may receive user input associated with one or more substrates. The UI may receive user input associated with the non-numeric data. The UI may receive user input associated with a visual depiction of substrate properties. The UI may receive user classification of substrates based on the non-numeric data. The UI may receive user input via a UI element, e.g., the UI element presenting the non-numeric data.

The user input may include a classification of a substrate. The user input may include a categorical classification, e.g., whether or not a substrate structure is present. The user input may include an ordinal classification, e.g., arranging substrates in an order according to some target property value.

Upon receiving user classification, analysis may be performed. The analysis may relate one or more substrate generation parameters to the substrate classification. The analysis may relate substrate simulation parameters to substrate properties, as classified by a user. The analysis may relate substrate manufacturing conditions to substrate properties, as classified by a user. The UI may further display results of the analysis, e.g., the UI may replace a chart displaying data associated with the substrates with a new chart depicting numeric data that is correlated to the classification. For example, data markers may be arranged along two axes corresponding to substrate generation parameters that are well correlated with the substrate classifications provided by a user.

One or more corrective actions may be performed in view of the analysis, based on the classifications, etc. Corrective actions may include providing an alert to a user. Corrective actions may include updating a process recipe. Corrective actions may include providing user classifications for training of a model, e.g., a machine learning model. Corrective actions may include scheduling generation of further substrates, e.g., to fill sparse regions of process space. Corrective actions may include updating a substrate processing simulation model.

Methods and systems of the present disclosure provide technical advantages over conventional methods. In conventional methods, developing analysis and/or recommendations based on a combination of numeric and non-numeric data may be cumbersome, inconvenient, costly, and/or difficult. For example, tools and methods that are well suited to making determinations based on numeric data may be poorly suited to making determinations based on non-numeric data. Tools and methods that are well suited to making determinations based on non-numeric data may be poorly suited to making determinations based on numeric data.

Some properties of a substrate (e.g., electrical properties, material properties, surface roughness, etc.) may be easily understood numerically. It may be possible to determine whether some properties of a substrate fall within a threshold window based on numeric data. Presenting such properties to a user for classification may be more difficult, e.g., a user may not have an intuitive understanding of a threshold acceptable variance of a target substrate property, for example.

Some properties of a substrate may be easily understood visually, e.g., whether or not a structure is present in a substrate, ordering of a target value of a substrate structure that includes some uncertainty in numerical measurement, or the like. Classification and/or determination of such substrate properties may be clear to a user using non-numeric data (e.g., visually presented data), while difficult to perform based on numeric data.

Methods and systems of the present disclosure enable efficient analysis and decision making based on a combination of numeric and non-numeric data. Determination may include determination of a recommended corrective action. Recommending corrective actions may be more accurate than basing corrective action recommendations on either numeric or non-numeric data alone. Recommending corrective actions may be more efficient utilizing a comprehensive method and/or system including both numeric and non-numeric data.

In one aspect of the present disclosure, a method includes obtaining, by a processing device, first data indicative of substrate generation parameters of a first substrate. The processing device further obtains second data indicative of properties of the first substrate. The processing device further obtains third data indicative of substrate generation parameters of a second substrate. The processing device further receives fourth data indicative of properties of the second substrate. The method further includes providing a user interface (UI). The UI includes a first UI element for presenting a visual depiction of the second data and a second UI element for presenting a visual depiction of the fourth data. The method further includes receiving user input of a classification of the first substrate and the second substrate. The method further includes performing analysis relating the first data and the third data to the user classifications. The method further includes performing a corrective action based on the analysis.

In another aspect of the present disclosure, a non-transitory machine-readable storage medium stores instructions which, when executed, cause a processing device to perform operations. The operations include obtaining first and second data indicative of processing conditions and properties of a first substrate. The operations further include obtaining third and fourth data indicative of properties of a second substrate. The operations further include providing a UI. The UI includes a first UI element for presenting a visual depiction of the second data and a second UI element for presenting a visual depiction of the fourth data. The operations further include receiving a first user input including a user classification of the first substrate in relation to the second data. The operations further include receiving a second user input including a user classification of the second substrate in relation to the fourth data. The operations further include performing analysis relating the first data and the third data to the first user classification and the second user classification. The operations further include performing a corrective action based on the analysis.

In another aspect of the present disclosure, a system includes memory and a processing device coupled to the memory. The processing device is configured to obtain first and second data indicative of processing conditions and properties of a first substrate. The processing device is further configured to obtain third and fourth data indicative of processing conditions and properties of a second substrate. The processing device is further configured to provide a UI. The UI includes a first and second UI element for presenting a visual depiction of the second and fourth data. The processing device is further configured to receive a first and second user input including first and second user classifications of the first and second substrates in relation to the second and fourth data. The processing device is further configured to perform analysis relating the first data and the third data to the first and second user classifications. The processing device is further configured to perform a corrective action based on the analysis.

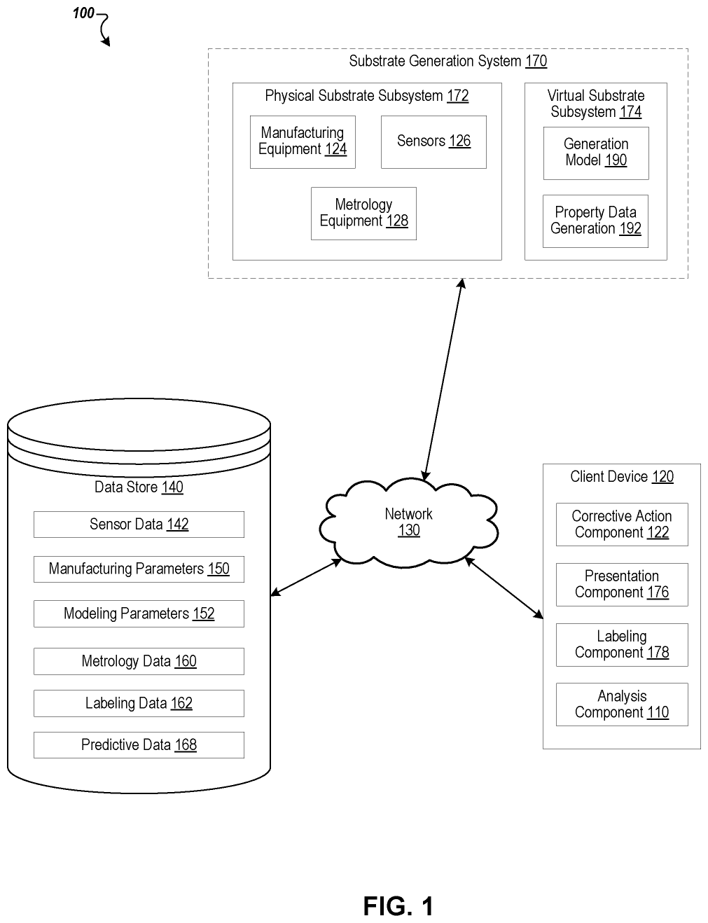

FIG. 1 is a block diagram illustrating an exemplary system 100 (exemplary system architecture), according to some embodiments. System 100 includes a client device 120, substrate generation system 170, and a data store 140. Substrate generation system 170 includes physical substrate subsystem 172 and virtual substrate subsystem 174.

Physical substrate subsystem 172 and virtual substrate subsystem 174 may include components for performing operations for substrate generation, substrate property data generation, numeric data generation, non-numeric data generation, etc. Physical substrate subsystem 172 includes manufacturing equipment 124. Manufacturing equipment 124 may include one or more process tools, process chambers, process equipment, etc., for producing physical substrates. Manufacturing equipment may be provided with and execute instructions for processing substrates, such as semiconductor wafers.

Physical substrate subsystem 172 includes sensors 126. Sensors 126 may provide sensor data 142 associated with manufacturing equipment 124 (e.g., associated with producing, by manufacturing equipment 124, corresponding products, such as substrates). Sensor data 142 may be used for ascertaining equipment health and/or product health (e.g., product quality). Manufacturing equipment 124 may produce products following a recipe or performing runs over a period of time. In some embodiments, sensor data 142 may include values of one or more of temperature (e.g., heater temperature), spacing (SP), pressure, High Frequency Radio Frequency (HFRF), radio frequency (RF) match voltage, RF match current, RF match capacitor position, voltage of Electrostatic Chuck (ESC), actuator position, electrical current, flow, power, voltage, etc.

Sensor data 142 may be associated with or indicative of manufacturing parameters such as hardware parameters (e.g., settings or components, e.g., size, type, etc.) of manufacturing equipment 124 or process parameters of manufacturing equipment 124. Data associated with some hardware parameters may, instead or additionally, be stored as manufacturing parameters 150. Manufacturing parameters 150 may be indicative of input settings to the manufacturing device (e.g., heater power, gas flow, etc.). Sensor data 142 and/or manufacturing parameters 150 may be provided while manufacturing equipment 124 is performing manufacturing processes (e.g., may be equipment readings generated during processing of substrates). Sensor data 142 may be different for each product (e.g., each substrate). Substrates may have property values (e.g., film thickness, film strain, etc.) measured by metrology equipment 128. Metrology data 160 may be a type of data stored in data store 140.

Virtual substrate subsystem 174 includes generation model 190. Generation model 190 is a model used for generating virtual substrates, e.g., based on simulation inputs. Generation model 190 may be a substrate processing simulation model. Generation model 190 may be a physics-based model. Generation model 190 may be a different kind of model, such as a machine learning model. Generation model 190 may produce virtual substrates as output based on substrate generation input, e.g., simulation inputs. Inputs to generation model 190 may be stored as modeling parameters 152 in data store 140. Modeling parameters 152 may be indicative of conditions resulting in generated virtual substrates.

Virtual substrate subsystem 174 includes property data generation 192. Property data generation 192 may generate data indicative of properties of virtual substrates. Property data generation 192 may generate numeric data indicative of substrate performance. Property data generation 192 may generate non-numeric data indicative of substrate performance. Properties of virtual substrates may be stored as manufacturing parameters 150, along with properties of physical substrates.

In some embodiments, sensor data 142, metrology data 160, modeling parameters 152, and/or manufacturing parameters 150 may be processed (e.g., by the client device 120). Processing of sensor data 142, metrology data 160, and/or manufacturing parameters 150 may include generating features. In some embodiments, the features are a pattern in the sensor data 142, metrology data 160, modeling parameters 152, and/or manufacturing parameters 150 (e.g., slope, width, height, peak, etc.) or a combination of values from the sensor data 142, metrology data 160, modeling parameters 152, and/or manufacturing parameters 150 (e.g., power derived from voltage and current, etc.). Sensor data 142 may include features and the features may be used by client device 120 for performing signal processing and/or for obtaining predictive data 168 for performance of a corrective action.

Each instance (e.g., set) of sensor data 142 may correspond to a product (e.g., a substrate), a set of manufacturing equipment, a type of substrate produced by manufacturing equipment, a substrate generation model, or the like. Each instance of metrology data 160, modeling parameters 152, and manufacturing parameters 150 may likewise correspond to a product, a set of manufacturing equipment, a type of substrate produced by manufacturing equipment, or the like. Data store 140 may further store information associating sets of different data types, e.g. information indicative that a set of sensor data, a set of metrology data, and a set of manufacturing parameters are all associated with the same product, manufacturing equipment, type of substrate, etc.

Client device 120, components of substrate generation system 170, and data store 140 may be coupled to each other via network 130 for generating predictive data 168 to perform corrective actions.

Client device 120 includes corrective action component 122, presentation component 176, labeling component 178, and analysis component 180. Client device 120 may perform various operations for interactive data labeling, substrate classification, predictive data generation, etc. Client device 120 may receive data indicative of one or more substrates. Client device 120 may receive data from metrology equipment 128, property data generation 192, data store 140, etc. Client device 120 may perform operations for generating predictive data 168 and/or recommending or performing corrective actions.

Presentation component 176 of client device 120 may present a user interface (UI). The UI may include one or more UI elements. The UI may present data associated with performance and/or properties of one or more substrates. Substrate data presented may include data from virtual substrates. Substrate data presented may include data from physical substrates or both virtual and physical substrates. Substrate data presented may include numeric data. Substrate data presented may include non-numeric data.

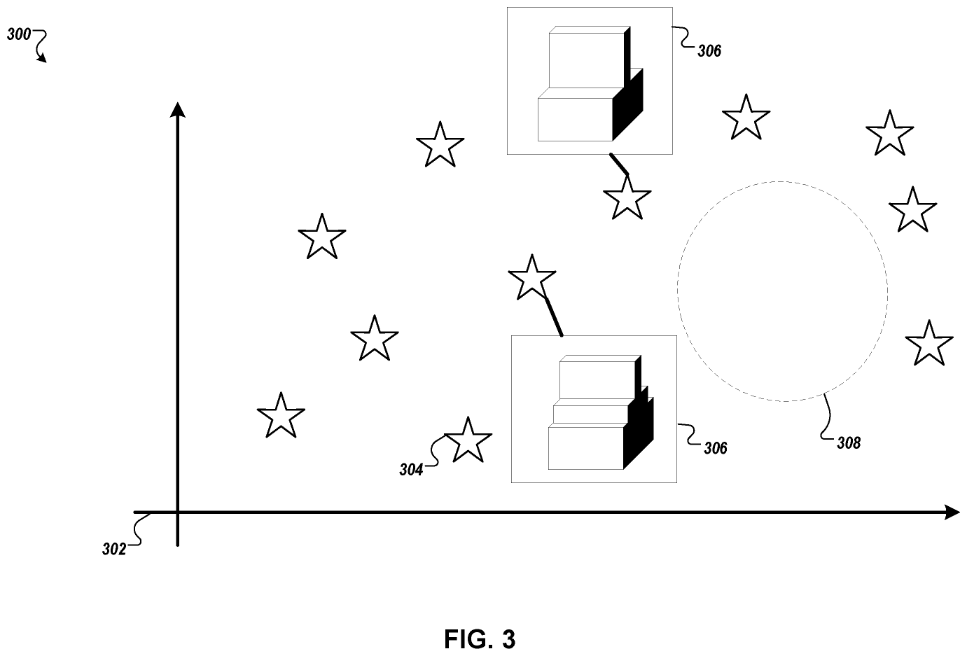

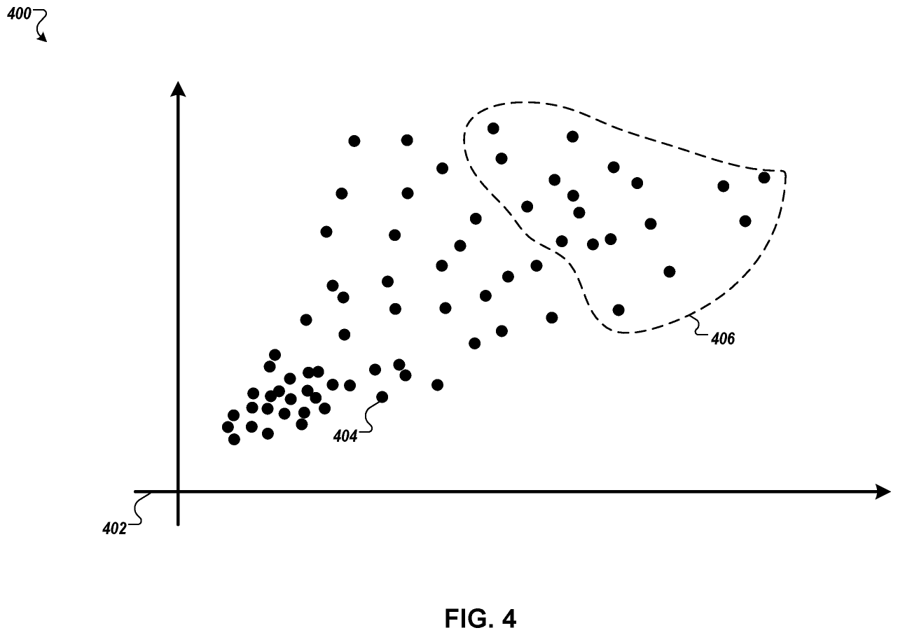

Labeling component 178 may enable a user to label substrate data based on one or more UI elements presented by presentation component 176. One or more UI elements may include visual data for labeling by a user. One or more UI elements may be configured to receive labeling by a user. Labeling component 178 may performs operations for receiving user classification of substrates, e.g., into groups based on substrate properties, into groups based on substrate suitability, etc. Labeling component 178 may perform operations for receiving user ordering of substrates, e.g., based on one or more substrate properties. Labeling component 178 may receive user labels of substrates based on non-numeric data, numeric data, a combination of numeric and non-numeric data, etc. User labels may be stored as labeling data 162. UI elements associated with receiving user labels are discussed in connection with FIGS. 3-4.

In some embodiments, sensor data 142, metrology data 160, modeling parameters 152, labeling data 162, and/or manufacturing parameters 150 may be processed (e.g., by the client device 120). Processing of sensor data 142, metrology data 160, labeling data 162, and/or manufacturing parameters 150 may include generating features. In some embodiments, the features are a pattern in the sensor data 142, metrology data 160, modeling parameters 152, labeling data 162, and/or manufacturing parameters 150 (e.g., slope, width, height, peak, etc.) or a combination of values from the sensor data 142, metrology data 160, modeling parameters 152, labeling data 162, and/or manufacturing parameters 150 (e.g., power derived from voltage and current, etc.).

In some embodiments, analysis component 110 of client device 120 may generate predictive data 168. Predictive data 168 may be indicative of a corrective action (which may be performed by corrective action component 122, for example). Analysis component 110 may generate predictive data 168 based on labels provided by users, e.g., labeling data 162. Analysis component 110 may perform analysis based on correlations between substrate generation parameters (e.g., modeling parameters 152, manufacturing parameters 150) and substrate properties (e.g., as labeled by a user). Analysis component 110 may perform an effect of adjusting substrate generation parameters on substrate properties.

In some embodiments, analysis component 110 may generate predictive data 168 utilizing a statistical model, such as a regression model, principle component analysis model, etc. In some embodiments, analysis component 110 may perform a fit based on substrate generation parameters and substrate labels.

In some embodiments, analysis component 110 may generate predictive data 168 using machine learning, such as supervised machine learning (e.g., a machine learning model may be configured to produce labels associated with input data, such as metrology predictions, performance predictions, etc.). In some embodiments, analysis component 110 may generate predictive data 168 using unsupervised machine learning (e.g., a machine learning model may be trained with unlabeled data, such as a model configured to perform clustering, dimensional reduction, etc.). In some embodiments, analysis component 110 may generate predictive data 168 using semi-supervised learning (e.g., a machine learning model may be trained using both labeled and unlabeled input data sets).

In some embodiments, network 130 is a public network that provides client device 120 with access to the data store 140, components of substrate generation system 170, and other publicly available computing devices. In some embodiments, network 130 is a private network that provides client device 120 access to manufacturing equipment 124, sensors 126, metrology equipment 128, data store 140, and other privately available computing devices. In some embodiments, the functions of one or more of client device 120 and/or analysis server 112 may be performed by a virtual machine, e.g., utilizing a cloud-based service. Network 130 may provide access to such virtual machines. Network 130 may include one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

Client device 120 may include a computing device such as Personal Computers (PCs), laptops, mobile phones, smart phones, tablet computers, netbook computers, network connected televisions (“smart TV”), network-connected media players (e.g., Blu-ray player), a set-top-box, Over-the-Top (OTT) streaming devices, operator boxes, etc. The client device 120 may include a corrective action component 122. Corrective action component 122 may receive user input (e.g., via a Graphical User Interface (GUI) displayed via the client device 120) of an indication associated with system 100.

In some embodiments, corrective action component 122 transmits an indication of a corrective action to substrate generation system 170, and causes the corrective action to be implemented. Causing the corrective action to be implemented may include updating one or more substrate generation operations, such as updating process recipes, updating simulation models, etc. Corrective action component 122 may implement one or more corrective actions, such as providing an alert to a user, recommending and/or scheduling maintenance, etc.

In some embodiments, metrology data 160 corresponds to historical property data of products. Predictive data 168 may include analysis results, e.g., output of analysis component 110, predicted system failure, corrective actions to be performed, maintenance to be performed, etc. In some embodiments, predictive data 168 is an indication of abnormalities (e.g., abnormal products, abnormal components, abnormal manufacturing equipment 124, abnormal energy usage, etc.) and optionally one or more causes of the abnormalities. In some embodiments, predictive data 168 is an indication of change over time or drift in some component of manufacturing equipment 124, sensors 126, metrology equipment 128, and the like. In some embodiments, predictive data 168 is an indication of an end of life of a component of manufacturing equipment 124, sensors 126, metrology equipment 128, or the like.

Performing manufacturing processes that result in defective products can be costly in time, energy, products, components, manufacturing equipment 124, the cost of identifying the defects and discarding the defective product, etc. By providing substrate data to a user, receiving a user label, performing analysis based on the label, and performing a corrective action based on the analysis, system 100 may reduce a likelihood of manufacturing equipment 124 producing defective products. For example, updating a process recipe or scheduling replacement of a failing component may reduce increase a likelihood of generating substrates by manufacturing equipment 124 that satisfy threshold performance metrics. System 100 can have the technical advantage of avoiding the cost of producing, identifying, and discarding defective products.

In some embodiments, virtual substrate generation may be intended to correspond to physical substrate generation, e.g., virtual substrate generation procedures may approximate physical substrate generation procedures for providing understanding of relationships between process inputs and substrate performance, without expending resources to generate a physical substrate. Performing virtual substrate generation operations that do not correspond to physical manufacturing processes may be costly. Incorrect actions may be performed in view of inaccurate virtual substrate generation operations, such as updating of process recipes, costly maintenance operations, etc. By providing substrate data to a user, receiving a user label, performing analysis based on the label, and performing a corrective action based on the analysis, system 100 may improve accuracy of virtual substrate generation operations. Improved performance of virtual substrate generation operations may enable accurate corrective actions to be performed, which may reduce manufacturing defects, enable optimal manufacturing parameters, reduce wasted energy, time, and materials in processing, reduce an environmental impact of substrate processing, etc.

Manufacturing parameters may be sub-optimal for producing product, which may have costly results of increased resource (e.g., energy, coolant, gases, etc.) consumption, increased amount of time to produce the products, increased component failure, increased amounts of defective products, etc. By providing substrate data to a user, receiving a user label, performing analysis based on the label, and performing a corrective action based on the analysis, system 100 can have the technical advantage of using optimal manufacturing parameters (e.g., hardware parameters, process parameters, optimal design) and/or healthy equipment to avoid costly results of sub-optimal manufacturing parameters.

Performing manufacturing processes that result in failure of the components of the manufacturing equipment 124 can be costly in downtime, damage to products, damage to equipment, express ordering replacement components, etc. By providing substrate data to a user, receiving a user label, performing analysis based on the label, and performing a corrective action based on the analysis, system 100 can have the technical advantage of avoiding the cost of one or more of unexpected component failure, unscheduled downtime, productivity loss, unexpected equipment failure, product scrap, or the like. Monitoring the performance over time of components, e.g. manufacturing equipment 124, sensors 126, metrology equipment 128, and the like, may provide indications of degrading components.

Manufacturing processes may have an environmental impact. Manufacturing parameters may be less than optimal for reducing an environmental impact of manufacturing processes. By providing substrate data to a user, receiving a user label, performing analysis based on the label, and performing a corrective action based on the analysis, system 100 may have the technical advantage of adjusting one or more manufacturing processes for reducing an environmental impact of manufacturing processes.

In some embodiments, the corrective action includes providing an alert. An alert may include an alarm to stop or not perform the manufacturing process on additional substrates if the predictive data 168 indicates a predicted abnormality, such as an abnormality of the product, a component, or manufacturing equipment 124, for example. In some embodiments, the corrective action includes providing feedback control (e.g., modifying a manufacturing parameter responsive to the predictive data 168 indicating a predicted abnormality). In some embodiments, performance of the corrective action includes causing updates to one or more manufacturing parameters.

Manufacturing parameters may include hardware parameters. Hardware parameters may include information indicating components included in the manufacturing equipment, indications of recently replaced components, indications of firmware versions or updates, etc. Manufacturing parameters may include process parameters. Process parameters may include set points for temperature, pressure, flow rate, electrical current and/or voltage, gas flow, lift speed, etc. In some embodiments, the corrective action includes causing preventative operative maintenance. Preventative operative maintenance may include instructions to replace, process, clean, etc. components of the manufacturing equipment 124. In some embodiments, the corrective action includes causing design optimization. Design optimization may include updating manufacturing parameters, updating manufacturing processes, updating manufacturing equipment 124, etc. for an optimized product or process. In some embodiments, the corrective action includes updating a recipe. Updating a recipe may include altering timing of instructions for manufacturing equipment 124 to be in an idle mode, a sleep mode, a warm-up mode, etc., adjusting set points for temperature, gas flow, plasma generation, etc.

Operations of virtual substrate subsystem 174 may be executed by one or more computing/processing devices. Devices for executing operations of virtual substrate subsystem may include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc. Operations of virtual substrate subsystems 174 may be performed by a cloud-based or virtual machine, in some embodiments.

In some embodiments, model 190 may include a trained physics-based digital twin model. The physics-based model may be capable of solving systems of equations describing physical phenomena that may occur in the manufacturing chamber, such as equations governing heat flow, energy balance, gas conductance, mass balance, fluid dynamics, electrical current flow, or the like. In some embodiments, the physics-based model performs calculations of component performance in the manufacturing chamber. Manufacturing parameters 150 may be provided to the trained physics-based model. The trained physics-based model may provide as output modeled property values indicative of conditions within the chamber, corresponding to sensors 126 disposed within the manufacturing chamber (e.g., manufacturing equipment 124). The output of the physics-based model may be stored in data store 140.

Data store 140 may be a memory (e.g., random access memory), a drive (e.g., a hard drive, a flash drive), a database system, or another type of component or device capable of storing data. Data store 140 may include multiple storage components (e.g., multiple drives or multiple databases) that may span multiple computing devices (e.g., multiple server computers). The data store 140 may store sensor data 142, manufacturing parameters 150, metrology data 160, labeling data 162, and predictive data 168. Data store 140 may be or include a cloud-based data storage device, a virtual data storage device, or the like.

In some embodiments, the functions of client device 120 and substrate generation system 170 may be provided by a fewer number of machines. For example, in some embodiments, client device 120 and virtual substrate subsystem 174 may be integrated into a single machine.

In general, functions described in one embodiment as being performed by client device 120 or substrate generation system 170 can also be performed by the other of the two components in other embodiments, if appropriate. In addition, the functionality attributed to a particular component can be performed by different or multiple components operating together. For example, in some embodiments, devices that execute operations of substrate generation system 170 may determine the corrective action based on the predictive data 168. In another example, client device 120 may determine the predictive data 168 based on output from substrate generation system 170, etc.

In addition, the functions of a particular component can be performed by different or multiple components operating together. For example, operations of client device 120 may be accessed as a service provided to other systems or devices through appropriate application programming interfaces (API).

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

Embodiments of the disclosure may be applied to data quality evaluation, feature enhancement, model evaluation, Virtual Metrology (VM), Predictive Maintenance (PdM), limit optimization, or the like.

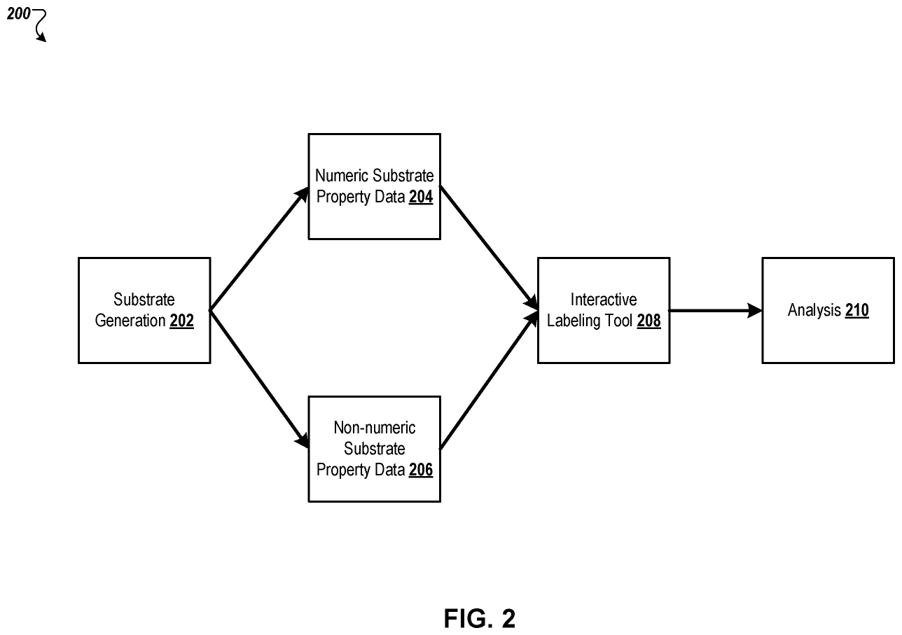

FIG. 2 depicts a flow 200 for utilizing numeric and non-numeric data for substrate processing operation analysis, according to some embodiments. Substrate generation 202 includes operations directed at generating one or more substrates. In some embodiments, virtual substrates may be generated. Generating virtual substrates may include providing input parameters to a model configured to generate as output data indicative of a virtual substrate. Generating virtual substrates may include providing input parameters to a substrate processing simulation model. Generating a virtual substrate may include providing input parameters to a physics-based model. Generating a virtual substrate may include providing input parameters to a machine learning model configured to predict substrate properties based on input parameters.

In some embodiments, physical substrates may be generated. Generating physical substrates may include providing manufacturing parameters to manufacturing equipment, processing equipment, one or more process tools, etc. Generating physical substrates may include performing processing operations on substrate material to generate a manufactured substrate. In some embodiments, a mix of physical and virtual substrates may be generated in substrate generation 202.

Property data associated with the one or more substrates may be generated. Numeric substrate property data 204 and non-numeric substrate property data 206 may be generated based on substrate generation 202. Numeric substrate property data 204 may be generated based on both virtual and physical substrates. Numeric substrate property data 204 may include indications of values of various substrate properties. Numeric substrate property data may include measurements of substrate geometry, substrate structure geometry, etc. Numeric substrate property data may include indications of film thickness, substrate optical properties, substrate chemical properties, substrate electrical properties, etc. Numeric substrate data may be included in output from a substrate generation model, e.g., numeric voxel data may be included in the virtual substrate. Numeric substrate data may be received from a metrology system. Numeric substrate data may be based on metrology operations performed on physical substrates. Numeric substrate data may be based on images taken by metrology equipment, e.g., measurement of dimensions of one or more features based on optical microscope data, scanning electron microscope (SEM) data, transmission electron microscope (TEM) data, or the like.

Non-numeric substrate property data 206 may be generated based on both virtual and physical substrates. Non-numeric substrate data may include visual depictions of data. Non-numeric substrate data may include images depicting substrate properties. Non-numeric substrate data may include images depicting substrate geometry. Non-numeric substrate data may include other visual data, such as a series of images, an animation, etc. Non-numeric substrate data may be generated in conjunction with a virtual substrate, e.g., a visual depiction of substrate geometry or other substrate properties may be generated. Non-numeric substrate data may be generated by a metrology system in conjunction with a physical substrate. For example, one or more images of a substrate may be generated by metrology tools, such as microscopes, SEM data, TEM data, cross-section microscopy data, etc.

Property data of substrates is provided to an interactive data labeling tool 208. Interactive data labeling tool 208 is configured to receive user input labeling data. Interactive data labeling tool 208 may present a user interface (UI) including data corresponding to one or more substrates. The UI may present substrate generation parameter data. The UI may present numeric substrate property data. The UI may present non-numeric substrate property data. The UI may receive labels of data from one or more users. The UI may receive classifications of substrates from one or more users. The UI may receive ordering of substrates from one or more users. The UI may receive classifications based on one or more properties of the substrates from a user. Example UIs are discussed in connection with FIGS. 3-4.

Data labels are provided for analysis 210. Analysis 210 may relate data labels to numeric substrate property data, non-numeric substrate property data, substrate generation parameters, or a combination of these. Analysis 210 may relate substrate classification and/or ordering to substrate generation parameters, such as simulation parameters or manufacturing parameters. Analysis 210 may include a determination of one or more root causes, e.g., root causes resulting in substrate properties related to user labeling. Analysis 210 may include a determination of one or more boundaries between regions of process space, e.g., regions of processing condition space associated with substrate classifications provided by user data labeling. Analysis 210 may include determined recommended corrective actions, e.g., in association with user-provided data labeling. Analysis 210 may include performance of corrective actions.

FIG. 3 depicts an example UI element 300 for receiving user labeling, according to some embodiments. UI element 300 includes plot 302. Plot 302 may depict data associated with substrate generation. Plot 302 may depict numeric data associated with substrate generation. Plot 302 includes markers 304. Each marker 304 may be associated with a substrate. Axes of plot 302 may correspond to numeric data associated with substrate processing, with marker locations demonstrating numeric data of substrate processing for a number of substrates.

In some embodiments, axes of plot 302 may correspond to numeric data associated with substrate processing. In some embodiments, one or more of the axes may correspond to values of an input parameter, e.g., a manufacturing parameter, a simulation parameter, etc. In some embodiments, one or more axes may correspond to values of substrate performance, such as numeric representations of substrate properties, substrate geometry, or the like. Marker locations may indicate numeric data associated with each substrate corresponding to the markers.

Additional UI elements 306 may be provided corresponding to non-numeric data for the substrates of plot 302. UI elements 306 may present non-numeric data to a user. UI elements 306 may present visual data to a user, e.g., images, animations, or the like. UI elements 306 may present non-numeric data associated with one or more substrates, associated with one or more markers 304, or the like. UI elements 306 may be presenting with indications for associated substrates or substrate markers. UI elements 306 may be displayed proximate an associated substrate marker. UI elements 306 may display images taken by metrology equipment of physical substrates. UI elements 306 may display images of virtual substrates. UI elements 306 may display computer aided design images of virtual substrates.

UI elements 306 may be used for a user to label data. For example, non-numeric data may be classified by a user. A user may classify substrates associated with the non-numeric data. For example, substrates may be classified based on the presence or absence of a structure, such as the shoulder structure depicted in UI elements 306.

In some embodiments, UI elements 306 may further provide a field for collecting user labeling. For example, UI elements 306 may include a drop-down selection menu, one or more check boxes, fillable field, or the like for collecting user labeling of substrates. UI elements 306 may collect user classification of substrates. In some embodiments, one or more separate UI elements may be presented to collect user labeling of data. In some embodiments, UI elements 306 may be displayed in association with one or more substrates. UI elements 306 may be displayed responsive to user selection of a substrate. UI elements 306 may be displayed responsive to user selection of a marker. User selection may include cursor selection, cursor dwell, or the like.

In some embodiments, user labels may be ordinal. For example, a non-numeric data associated with a set of substrates may be presented. A user may indicate, via a UI element, an ordering of a target property of the substrates. For example, a set of substrates may be ordered based on depth of a trench, critical dimension, or some other substrate performance metric. Analysis may further be performed based on user labels, user classification, user ordering, etc.

In some embodiments, plot 302 may be used for determining generation of substrates. For example, region 308 has no substrates in the indicated region of process space (e.g., processing condition space). A user may utilize one or more UI elements to recommend and/or initiate generation of additional substrates, e.g., to fill portions of process space with few substrates, to augment portions of process space that include uncertain data, or the like.

In some embodiments, a processing device may perform analysis based on user labeling of data. A processing device may perform analysis operations based on user labeling of substrates. A processing device may perform analysis operations based on user classification or ordering of substrates. In some embodiments, analysis may provide contouring or boundaries between regions of process space. For example, analysis may predict boundaries between regions of input space that correspond to various classifications of substrate output. Analysis may predict a boundary between a first region of process parameter space corresponding to a first classification of substrate performance and a second region of process parameter space corresponding to a second classification of substrate performance.

A processing device may adjust plot 302 in view of the analysis. For example, numeric data associated with axes of plot 302 may be changed to incorporate process parameters that are most highly correlated with the user-provided labels. Axes of plot 302 may be changed to demonstrate effects of changing substrate generation parameters on substrate properties, substrate performance, etc. The processing device may further recommend one or more corrective actions, including generation of additional substrates, updating a process recipe, recommending maintenance, updating a process simulation, or the like. In some embodiments, user classifications may be provided to a model, e.g., as target output for training a machine learning model. In some embodiments, a corrective action may include providing an alert to a user.

FIG. 4 depicts an example UI element 400 for receiving user labeling of data, according to some embodiments. UI element 400 includes plot 402 and markers 404, which may share one or more features with similar aspects of UI element 300 of FIG. 3.

UI element 400 includes label group 406. Label group 406 may include a set of data that a user labels or classifies together. UI elements may be displayed in association with markers 404 (non shown), which may be used by a user in classifying data associated with the markers 404. In some embodiments, a method of display of markers 404 may present additional data. For example, markers 404 may vary in color, size, or pattern, based on differences in data. Presentation of markers 404 may vary based on numeric or non-numeric data. Presentation of markers 404 may vary based on substrate property data. A user may label a set of markers together, using a grouping tool to generate a label group, e.g., label group 406. For example, markers 404 may represent a range of target data values, represented by a color gradient. A user may determine that a first set of markers represent substrates that satisfy a threshold condition, based on marker color. The user may use a tool (e.g., a lasso tool) to designate a group (e.g., label group 406) and classify all substrates associated with the group into the same classification category. The user may designate a group to label as occupying a portion of an ordinal spectrum, e.g., all points included in label group 406 may be labeled as belonging to roughly one extreme of an ordering of substrates based on a target substrate property value.

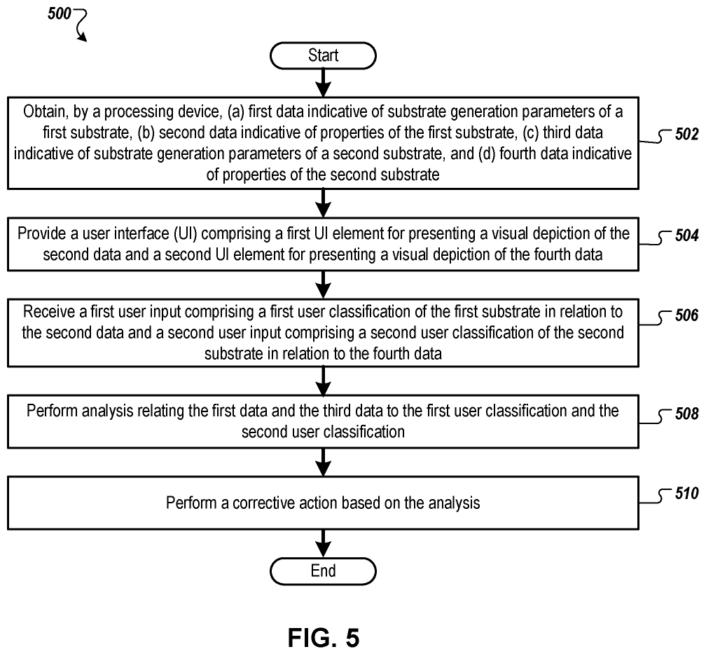

FIG. 5 is a flow diagram of a method 500 for performing corrective actions based on interactive data labeling, according to some embodiments. At block 502, processing logic obtains data. The data includes data associated with two substrates. The data includes generation data and property data of the substrates. The data obtained by the processing device includes data indicative of substrate generation parameters of the first and second substrate. The data obtained by the processing device includes indications of properties of the first and second substrates.

Substrate generation parameters may include simulation parameters, such as simulation input parameters, simulation parameter values, simulated processing conditions, etc. Substrate generation parameters may include manufacturing parameters, such as recipe data, condition set points, etc. Manufacturing parameters may correspond to process conditions for substrate processing. Substrate generation parameters may include measurements related to recipes, such as sensor data or virtual sensor data indicative of substrate processing conditions. Substrate generation parameters may include numeric data, e.g., data comprehended in a numeric form.

Data indicative of properties of substrates may include performance data, material data, dimensions of substrates, etc. Substrate property data may be non-numeric, e.g., may be data that is comprehended in a non-numeric form, in a visual form, etc.

In some embodiments, one or more substrates associated with method 500 may be virtual substrates. Generating the virtual (e.g., simulated) substrates may include providing simulation parameters to a substrate processing simulation model. Output from the substrate processing simulation model may include data indicative of properties of the virtual substrates. In some embodiments, one or more substrates associated with method 500 may be physical substrates. Generating a physical substrate may include processing a substrate utilizing processing conditions, e.g., processing conditions corresponding to the substrate generation parameters obtained by the processing device at block 502. Generating substrate property data may include providing a physical substrate to a metrology tool and performing one or more metrology operations on the substrate to generate substrate metrology data. Substrate property data may include one or more images based on the metrology data.

At block 504, processing logic provides a UI. The UI includes a first UI element. The first UI element presents a visual depiction of property data of the first substrate. A second UI element is presented that includes a visual depiction of property data of the second substrate. One or more UI elements may include images depicting geometry of the substrates. The UI may further include one or more plots, e.g., for displaying numeric data associated with substrates, for displaying substrate generation parameter space associated with generation of the first and second substrates, etc. UI elements may be provided for displaying non-numeric data associated with substrates. The UI may display markers associated with the substrates, e.g., on one or more plots. The UI may display a UI element indicating non-numeric data associated with a substrate proximate a marker associated with the substrate.

At block 506, processing logic receives first user input. The user input may be provided via the UI. The user input may include user classifications of the first and second substrate. The user input may include user classifications based on the substrate property data of the first and second substrates. The user input may include user classifications based on non-numeric data. The user input may include a ranking of the first and second substrates, based on values of some target property. For example, substrates presented by the UI may be ordered by a user based on size of a target feature.

At block 508, processing logic performs analysis relating the substrate generation parameters to the user provided classifications (e.g., user provided labels). The analysis may determine which substrate generation parameters are most highly correlated with the user input. The analysis may determine which substrate generation parameters are most highly correlated with substrate classifications. In some embodiments, the UI may be updated in view of the analysis. For example, the UI may be updated to depict one or more correlation relationships between substrate parameters and substrate properties, substrate generation parameters and substrate classifications, etc. In some embodiments, the analysis may include determining one or more boundaries in regions of substrate generation parameter space. For example, the analysis may predict regions of substrate generation parameter space related to one or more user-provided classifications of substrate properties.

At block 510, processing logic performs a corrective action based on the analysis. The corrective action may include updating a process recipe. The corrective action may include providing the user labeling for training a model, such as a machine learning model. The corrective action may include providing an alert to a user. The corrective action may include scheduling generation of further substrates, e.g., corresponding to poorly represented regions of substrate generation parameter space, substrate property space, etc. The corrective action may include updating a substrate processing simulation model, e.g., selection of a different substrate processing simulation model for one or more regions of substrate generation parameter space.

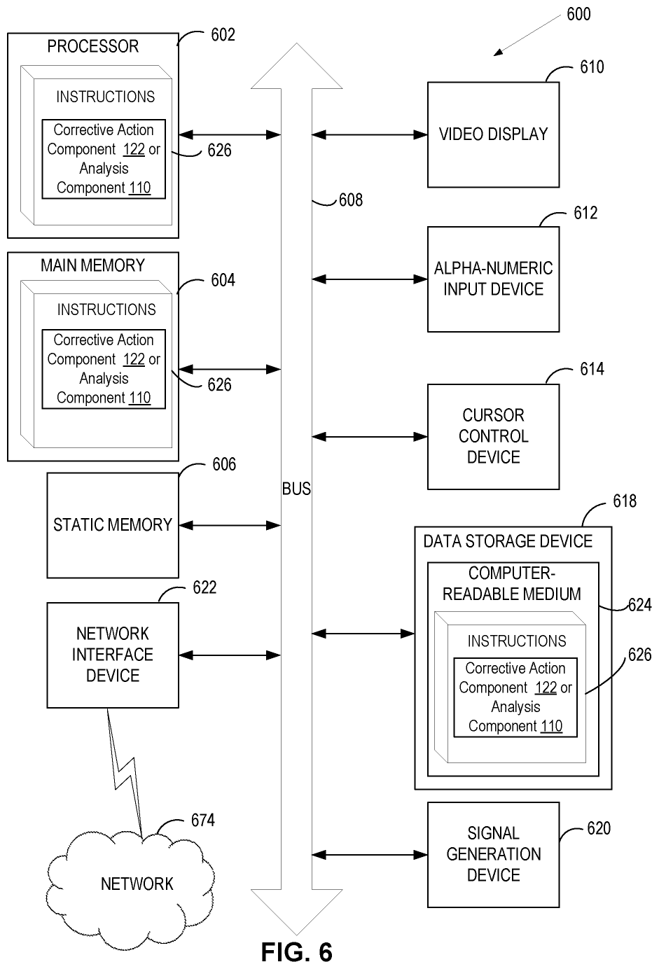

FIG. 6 is a block diagram illustrating a computer system 600, according to some embodiments. In some embodiments, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., Random Access Memory (RAM)), a non-volatile memory 606 (e.g., Read-Only Memory (ROM) or Electrically-Erasable Programmable ROM (EEPROM)), and a data storage device 618, which may communicate with each other via a bus 608.

Processing device 602 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 600 may further include a network interface device 622 (e.g., coupled to network 674). Computer system 600 also may include a video display unit 610 (e.g., an LCD), an alphanumeric input device 612 (e.g., a keyboard), a cursor control device 614 (e.g., a mouse), and a signal generation device 620.

In some embodiments, data storage device 618 may include a non-transitory computer-readable storage medium 624 (e.g., non-transitory machine-readable medium) on which may store instructions 626 encoding any one or more of the methods or functions described herein, including instructions encoding components of FIG. 1 (e.g., analysis component 110, corrective action component 122, substrate generation model 190, etc.) and for implementing methods described herein. Instruction 626 may encode functions performed by additional components, including property data generation 192, presentation component 176, labeling component 178, etc.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “determining,” “using,” “training,” “generating,” “correcting,” “updating,” “scheduling,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

What is claimed is:

1. A method, comprising:
obtaining, by a processing device:
first data indicative of substrate generation parameters of a first substrate,
second data indicative of properties of the first substrate,
third data indicative of substrate generation parameters of a second substrate, and
fourth data indicative of properties of the second substrate;
providing a user interface (UI), the UI comprising a first UI element for presenting a visual depiction of the second data and a second UI element for presenting a visual depiction of the fourth data;
receiving a first user input comprising a first user classification of the first substrate in relation to the second data and a second user input comprising a second user classification of the second substrate in relation to the fourth data;
performing analysis relating the first data and the third data to the first user classification and the second user classification; and
performing a corrective action based on the analysis.

2. The method of claim 1, wherein generating the second data comprises:
providing first simulation parameters associated with the first data to a substrate processing simulation model; and
obtaining output indicative of the second data from the substrate processing simulation model, wherein the first substrate is a simulated substrate.

3. The method of claim 2, wherein generating the fourth data comprises:
processing a substrate using process conditions indicated by the third data;
performing one or more metrology operations to generate substrate metrology data of the substrate; and
producing one or more images based on the substrate metrology data, wherein the fourth data comprises the one or more images.

4. The method of claim 1, wherein the UI further comprises:
a plot displaying a first data marker associated with the first substrate and a second data marker associated with the second substrate, wherein the plot indicates values of a first substrate generation parameter and a second substrate generation parameter associated with the first substrate and the second substrate, and wherein the first UI element is displayed proximate the first data marker and the second UI element is displayed proximate the second data marker.

5. The method of claim 1, wherein the first UI element comprises a visualization of geometry of the first substrate.

6. The method of claim 1, further comprising:
determining, based on the analysis, that values of a first substrate generation parameter of the first data and the third data are correlated with the first user classification and the second user classification; and
updating the UI to display data indicative of an effect of values of the first substrate generation parameter on substrate properties.

7. The method of claim 1, wherein the corrective action comprises:
updating a process recipe;
providing the first user classification for training a machine learning model;
providing an alert to a user;
scheduling generation of a third substrate; or
updating a substrate processing simulation model.

8. The method of claim 1, wherein the analysis comprises determining a boundary between a first region of substrate generation parameter space associated with a first property corresponding to the first substrate and a second region of processing condition space associated with a second property corresponding to the second substrate.

9. The method of claim 1, wherein the first user classification and the second user classification comprise a ranking of a target property of the first and second substrates.

10. A non-transitory machine-readable storage medium storing instructions which, when executed, cause a processing device to perform operations comprising:
obtaining:
first data indicative of processing conditions of a first substrate,
second data indicative of properties of the first substrate,
third data indicative of processing conditions of a second substrate, and
fourth data indicative of properties of the second substrate;
providing a user interface (UI), the UI comprising a first UI element for presenting a visual depiction of the second data and a second UI element for presenting a visual depiction of the fourth data;
receiving a first user input comprising a first user classification of the first substrate in relation to the second data and a second user input comprising a second user classification of the second substrate in relation to the fourth data;
performing analysis relating the first data and the third data to the first user classification and the second user classification; and
performing a corrective action based on the analysis.

11. The non-transitory machine-readable storage medium of claim 10, wherein generating the second data comprises:
providing first processing conditions associated with the first data to a substrate processing simulation model; and
obtaining output indicative of the second data from the substrate processing simulation model, wherein the first substrate is a simulated substrate.

12. The non-transitory machine-readable storage medium of claim 10, wherein the UI further comprises:
a plot displaying a first data marker associated with the first substrate and a second data marker associated with the second substrate, wherein the plot indicates values of a first processing condition and a second processing condition associated with the first substrate and the second substrate, and wherein the first UI element is displayed proximate the first data marker and the second UI element is displayed proximate the second data marker.

13. The non-transitory machine-readable storage medium of claim 10, the operations further comprising:
determining, based on the analysis, that values of a first processing condition of the first data and the third data are correlated with the first user classification and the second user classification; and
updating the UI to display data indicative of an effect of values of the first processing condition on substrate properties.

14. The non-transitory machine-readable storage medium of claim 10, wherein the corrective action comprises one or more of:
updating a process recipe;
providing the first user classification for training a machine learning model;
providing an alert to a user;
scheduling generation of a third substrate; or
updating a substrate processing simulation model.

15. The non-transitory machine-readable storage medium of claim 10, wherein the first user classification and the second user classification comprise a ranking of a target property of the first and second substrates.

16. A system, comprising memory and a processing device coupled to the memory, wherein the processing device is configured to:
obtain:
first data indicative of processing conditions of a first substrate,
second data indicative of properties of the first substrate,
third data indicative of processing conditions of a second substrate, and
fourth data indicative of properties of the second substrate;
provide a user interface (UI), the UI comprising a first UI element for presenting a visual depiction of the second data and a second UI element for presenting a visual depiction of the fourth data;
receive a first user input comprising a first user classification of the first substrate in relation to the second data and a second user input comprising a second user classification of the second substrate in relation to the fourth data;
perform analysis relating the first data and the third data to the first user classification and the second user classification; and
perform a corrective action based on the analysis.

17. The system of claim 16, wherein generating the second data comprises:
providing first processing conditions associated with the first data to a substrate processing simulation model; and
obtaining output indicative of the second data from the substrate processing simulation model, wherein the first substrate is a simulated substrate.

18. The system of claim 16, wherein the UI further comprises:
a plot displaying a first data marker associated with the first substrate and a second data marker associated with the second substrate, wherein the plot indicates values of a first processing condition and a second processing condition associated with the first substrate and the second substrate, and wherein the first UI element is displayed proximate the first data marker and the second UI element is displayed proximate the second data marker.

19. The system of claim 16, wherein the processing device is further configured to:
determine, based on the analysis, that values of a first processing condition of the first data and the third data are correlated with the first user classification and the second user classification; and
update the UI to display data indicative of an effect of values of the first processing condition on substrate properties.

20. The system of claim 16, wherein the first user classification and the second user classification comprise a ranking of a target property of the first and second substrates.
